(19) United States
(12) Patent Application Publication
(10) Pub. No.: US 2020/0045736 A1
(43) Pub. Date: Feb. 6, 2020

(54) RANDOMIZED FREQUENCY LOCATIONS FOR CONFIGURED UPLINK GRANTS

(71) Applicant: QUALCOMM Incorporated, San Diego, CA (US)

(72) Inventors: Linhai HE, San Diego, CA (US); Chih-Ping LI, San Diego, CA (US)

(21) Appl. No.: 16/529,340

(22) Filed: Aug. 1, 2019

Related U.S. Application Data
(60) Provisional application No. 62/714,058, filed on Aug. 2, 2018.

(51) Int. Cl. H04W 74/08; H04W 72/14; H04L 5/10; H04L 5/00; H04W 76/27; H04B 1/7143; H04W 76/11

(52) U.S. Cl. CPC H04W 74/0808; H04W 72/14; H04L 5/10; H04W 76/11; H04W 76/27; H04B 1/7143; H04L 5/0051

(57) ABSTRACT

Certain aspects of the present disclosure provide techniques for randomized frequency locations for uplink grants. The uplink grants may be “Type-1” uplink grants. The uplink grants may be used to schedule resources for ultra-reliable low-latency communications (URLLC) in new radio (NR) or 5G access. Aspects provide a method for wireless communication by a base station (BS). The BS transmits one or more uplink grants configuring a set of user equipments (UEs) with a plurality of transmission opportunities (TOs) available for uplink transmission by the set of UEs and a plurality of frequency locations associated with each TO. The BS configures the set of UEs for randomly determining one of the plurality of associated frequency locations for each of the configured TOs, for uplink transmission. The BS receives uplink transmissions from at least two of the set of UEs in at least one of the configured TOs at different frequency locations.

### CROSS-REFERENCE TO RELATED APPLICATION(S)

This application claims benefit of and priority to U.S. Provisional Patent Application Ser. No. 62/714,058, filed Aug. 2, 2018, herein incorporated by reference in its entirety as if fully set forth below and for all applicable purposes.

### BACKGROUND

### Field of the Disclosure

Aspects of the present disclosure relate to wireless communications, and more particularly, to techniques for randomized frequency locations for configured uplink grants.

### Description of Related Art

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These multiple access technologies have been adopted in various telecommunication standards to provide a common protocol that enables different wireless devices to communicate on a municipal, national, regional, and even global level. NR (e.g., new radio or 5G) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### BRIEF SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications between access points and stations in a wireless network.

Certain aspects provide a method for wireless communication by a user equipment (UE). The method generally includes receiving one or more uplink grants from a base station (BS) configuring a plurality of transmission opportunities (TOs) for uplink transmission by the UE and a plurality of frequency locations associated with each TO. The method includes randomly determining one of the plurality of associated frequency locations, for each of the configured TOs, for uplink transmission in the TO. The method includes sending one or more uplink transmissions to the BS in one or more of the configured TOs at the randomly determined frequency locations for the one or more TOs.

Certain aspects provide a method for wireless communication by a BS. The method generally includes transmitting one or more uplink grants configuring a set of UEs with a plurality of TOs available for uplink transmission by the set of UEs and a plurality of frequency locations associated with each TO. The method includes configuring the set of UEs for randomly determining one of the plurality of associated frequency locations, for each of the configured TOs, for uplink transmission in the TO. The method includes receiving uplink transmissions from at least two of the set of UEs in at least one of the configured TOs at different frequency locations.

Certain aspects provide an apparatus for wireless communication, such as a UE. The apparatus generally includes means for receiving one or more uplink grants from a BS configuring a plurality of TOs for uplink transmission by the apparatus and a plurality of frequency locations associated with each TO. The apparatus includes means for randomly determining one of the plurality of associated frequency locations, for each of the configured TOs, for uplink transmission in the TO. The apparatus includes means for sending one or more uplink transmissions to the BS in one or more of the configured TOs at the randomly determined frequency locations for the one or more TOs.

Certain aspects provide another apparatus for wireless communication, such as a BS. The apparatus generally includes means for transmitting one or more uplink grants configuring a set of UEs with a plurality of TOs available for uplink transmission by the set of UEs and a plurality of frequency locations associated with each TO. The apparatus includes means for configuring the set of UEs for randomly determining one of the plurality of associated frequency locations, for each of the configured TOs, for uplink transmission in the TO. The apparatus includes means for receiving uplink transmissions from at least two of the set of UEs in at least one of the configured TOs at different frequency locations.

Certain aspects provide an apparatus for wireless communication, such as a UE. The apparatus generally includes a receiver configured to receive one or more uplink grants from a BS configuring a plurality of TOs for uplink transmission by the apparatus and a plurality of frequency locations associated with each TO. The apparatus includes at least one processor coupled with a memory and configured to randomly determine one of the plurality of associated frequency locations, for each of the configured TOs, for uplink transmission in the TO. The apparatus includes a transmitter configured to send one or more uplink transmissions to the BS in one or more of the configured TOs at the randomly determined frequency locations for the one or more TOs.

Certain aspects provide another apparatus for wireless communication, such as a BS. The apparatus generally includes a transmitter configured to transmit one or more uplink grants configuring a set of UEs with a plurality of TOs available for uplink transmission by the set of UEs and a plurality of frequency locations associated with each TO. The apparatus includes at least one processor coupled with a memory and configured to configure the set of UEs for randomly determining one of the plurality of associated frequency locations, for each of the configured TOs, for uplink transmission in the TO. The apparatus includes a receiver configured to receive uplink transmissions from at least two of the set of UEs in at least one of the configured TOs at different frequency locations.

Certain aspects provide a computer readable medium having computer executable code stored thereon for wireless communication by a UE. The computer readable medium generally includes code for receiving one or more uplink grants from a BS configuring a plurality of TOs for uplink transmission by the UE and a plurality of frequency locations associated with each TO. The computer readable medium includes code for randomly determining one of the plurality of associated frequency locations, for each of the configured TOs, for uplink transmission in the TO. The computer readable medium includes code for sending one or more uplink transmissions to the BS in one or more of the configured TOs at the randomly determined frequency locations for the one or more TOs.

Certain aspects provide a computer readable medium having computer executable code stored thereon for wireless communication by a BS. The computer readable medium generally includes code for transmitting one or more uplink grants configuring a set of UEs with a plurality of TOs available for uplink transmission by the set of UEs and a plurality of frequency locations associated with each TO. The computer readable medium includes code for configuring the set of UEs for randomly determining one of the plurality of associated frequency locations, for each of the configured TOs, for uplink transmission in the TO. The computer readable medium includes code for receiving uplink transmissions from at least two of the set of UEs in at least one of the configured TOs at different frequency locations.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example telecommunications system, in accordance with certain aspects of the present disclosure.

FIG. 2 shows example transmission occasions (TOs) scheduled by Type-1 uplink grants.

FIG. 3 illustrates example operations for wireless communications by a user equipment (UE), in accordance with certain aspects of the present disclosure.

FIG. 4 illustrates example operations for wireless communications by a base station (BS), in accordance with certain aspects of the present disclosure.

FIG. 5 shows example TOs scheduled by Type-1 uplink grants with frequency hopping, in accordance with certain aspects of the present disclosure.

FIG. 6 illustrates a communications device that may include various components configured to perform operations for the techniques disclosed herein in accordance with aspects of the present disclosure.

FIG. 7 illustrates another communications device that may include various components configured to perform operations for the techniques disclosed herein in accordance with aspects of the present disclosure.

FIG. 8 is a block diagram conceptually illustrating a design of an example BS and UE, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for randomized frequency locations for configured uplink grants.

Some wireless networks may use uplink grants to schedule user equipments (UEs) with resources for uplink transmission. In some examples, the network uses a Type-1 configured uplink grant to schedule a UE. The Type-1 configured uplink grant, configures a sequence (or sequences) of transmission occasions (TOs) that are shared by the UEs and fixed in the time and frequency domains. In some cases, collisions occur between UEs that transmit in the same TO.

Techniques for avoiding collisions between UEs with Type-1 uplink grants are desirable. Aspects of the present disclose provide for randomized frequency locations for uplink grants using random selection and/or frequency hopping of the frequency locations for transmission in different configured TOs.

The following description provides examples of randomized frequency locations for configured uplink grants, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs. In some cases, a 5G NR RAT network may be deployed.

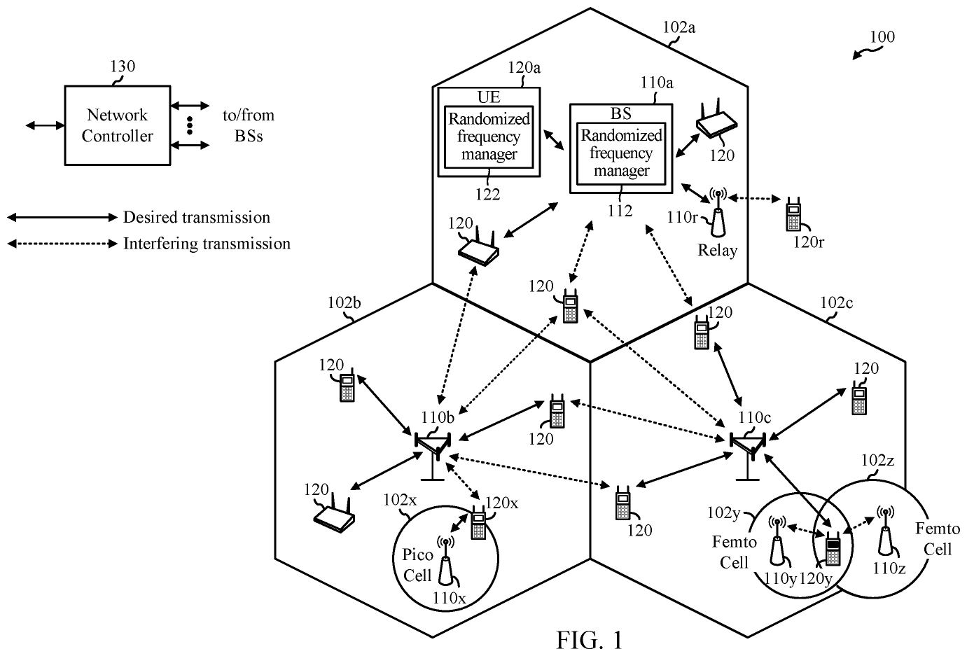

FIG. 1 illustrates an example wireless communication network 100 in which aspects of the present disclosure may be performed. For example, the wireless communication network 100 may be a new radio system (e.g., 5G NR).

As illustrated in FIG. 1, the wireless communication network 100 may include a number of base stations (BSs) 110a-z (each also individually referred to herein as BS 110 or collectively as BSs 110) and other network entities. A BS 110 may provide communication coverage for a particular geographic area, sometimes referred to as a “cell”, which may be stationary or may move according to the location of a mobile BS 110. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple cells. The BSs 110 communicate with user equipment (UEs) 120a-y (each also individually referred to herein as UE 120 or collectively as UEs 120) in the wireless communication network 100. The UEs 120 (e.g., 120x, 120y, etc.) may be dispersed throughout the wireless communication network 100, and each UE 120 may be stationary or mobile.

As shown in FIG. 1, the BS 110a in the wireless communication network 100 has a randomized frequency manager 112. The randomized frequency manager 112 may be configured to transmit uplink grants (e.g., type-1 configured uplink grants) to a set of UEs, such as including the UE 120a in the wireless communication network 100 to configure the UEs 120 with a sequence of TOs shared by the UEs 120 and with a set of frequency locations associated with each of the TOs, in accordance with aspect of the present disclosure. The randomized frequency manager 112 may configure the UEs 120 for randomly determining one of the associated frequency locations to use for each of the TOs, in accordance with aspect of the present disclosure. The BS 110a receives uplink transmissions from at least two of the UEs 120 at different frequency locations in at least one of the TOs, in accordance with aspect of the present disclosure. As shown in FIG. 1, the UE 120a has a randomized frequency manager 122. The randomized frequency manager 122 may be configured to receive the uplink grants from the BS 110a, randomly determine the frequency locations for the configured TOs, and send uplink transmissions to the BS 110a in the configured TOs at the determined frequency locations, in accordance with aspect of the present disclosure.

Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

A network controller 130 may couple to a set of BSs and provide coordination and control for these BSs. The network controller 130 may communicate with the BSs 110 via a backhaul. The BSs 110 may also communicate with one another (e.g., directly or indirectly) via wireless or wireline backhaul.

In FIG. 1, a solid line with double arrows indicates desired transmissions between a UE and a serving BS, which is a BS designated to serve the UE on the downlink and/or uplink. A finely dashed line with double arrows indicates interfering transmissions between a UE and a BS.

As mentioned above, uplink grants are transmitted by the BS to schedule UEs with resources for uplink transmission. Type-1 uplink grants configure a sequence of uplink grants (e.g., in sequential time durations), where each uplink grant schedules a TO. The sequence of TOs configured by the Type-1 uplink grants is shared among multiple (e.g., a set of) UEs. The sequence of TOs is pre-scheduled and fixed in the time and frequency domain. For example, each UE is configured with a period, offset, repetition K, and demodulation reference signal (DMRS). The period defines a duration in which the sequence of TOs is configured. The offset defines a time offset from the beginning of the period to the start of the sequence of TOs. The repetition K may define the number of repeated TOs that are configured in the period (e.g., the number of TOs in the sequence of TOs). There may be multiple configured periods, the periods may have the same configured duration, offset, and repetition, or may have different configurations.

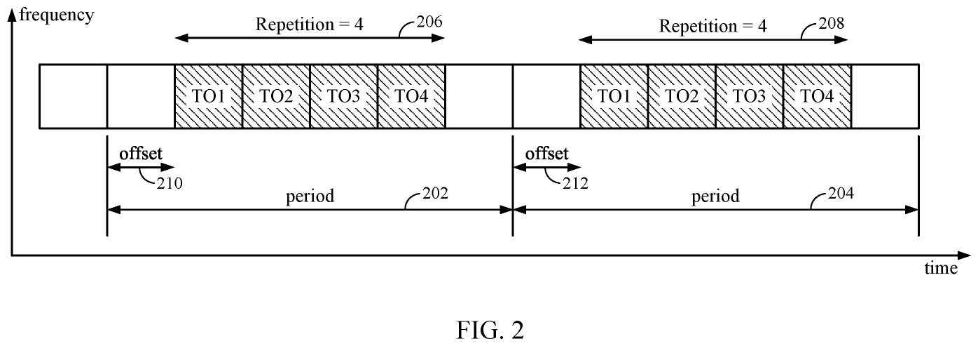

FIG. 2 shows example TOs scheduled by Type-1 uplink grants. As shown in FIG. 2, sequences of TOs 206 and 208 are scheduled in the periods 202 and 204, respectively. In the example shown in FIG. 2, the TOs are scheduled with four repetitions (TO 1, TO 2, TO 3, TO 4) with each sequences of TOs 206 and 208 starting at offset 210 and 212, respectively, from the beginning of the periods 202 and 204. In some cases, as shown in FIG. 2, the sequence of TOs is consecutive although, in some cases, the TOs or some of the TOs may not be consecutive (not shown).

In some cases, the network ‘overbooks’ the UEs, for example, to ensure efficient use of radio resources. Overbooking may cause collision between UEs. Collision occurs when two UEs with the same configured offset and DMRS transmit at the same time (e.g., in the same TO). One expected use case for Type-1 configured grants is for ultra-reliable low-latency communication (URLLC), which requires short periodicity. Collisions, however, are undesirable for URLLC because URLLC requires high reliability and collisions make the transmission less reliable. Further, if the UEs' traffic is cyclic, the collisions may continue to occur in subsequent grants.

Therefore, techniques for avoiding collisions for Type-1 uplink grants are desirable.

### Example Randomized Frequency Locations for Configured Uplink Grants

Aspects of the present disclose provide for randomized frequency locations for uplink grants. In some examples, the frequency locations are achieved using random selection and/or frequency hopping of the frequency locations for transmission in different configured TOs.

According to certain aspects, the Type-1 configured uplink grant may schedule resources that overlap in time, but at different frequency locations. Each TO is associated with a plurality of available frequency locations. Thus, in each TO, the UEs can randomly select frequency locations from the set of available frequency locations associated with that TO.

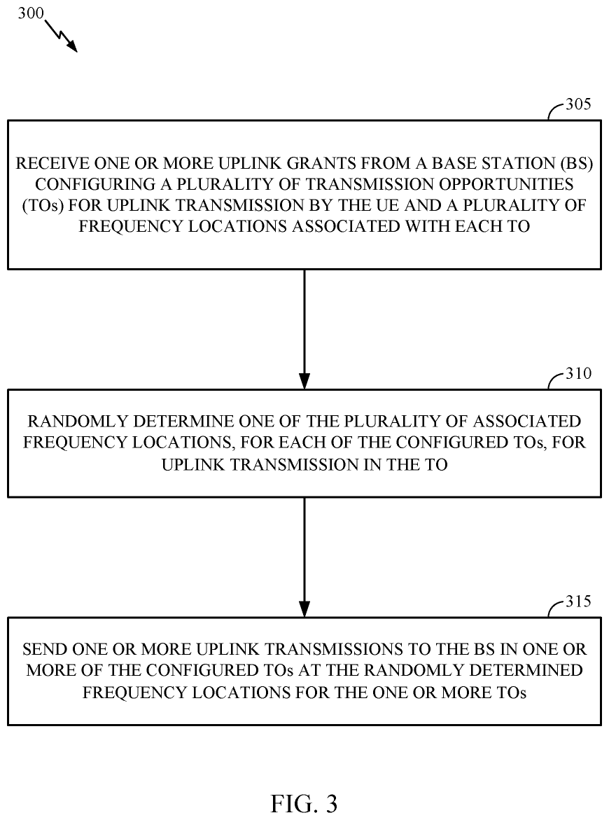

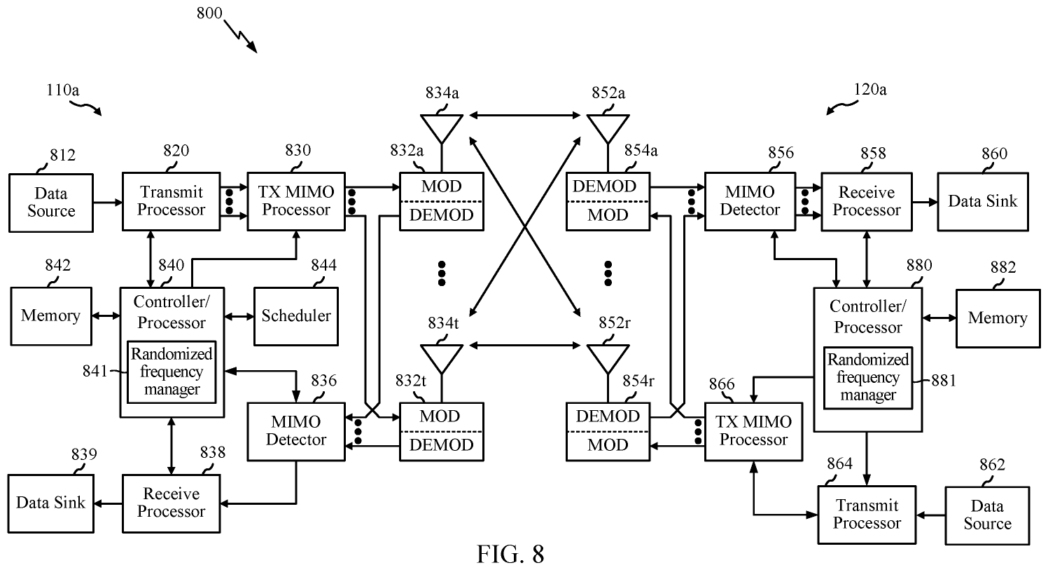

FIG. 3 illustrates example operations 300 for wireless communications, in accordance with certain aspects of the present disclosure. The operations 300 may be performed, for example, by UE (e.g., such as the UE 120a in the wireless communication network 100). Operations 300 may be implemented as software components that are executed and run on one or more processors (e.g., controller/processor 880 of FIG. 8). Further, the transmission and reception of signals by the UE in operations 800 may be enabled, for example, by one or more antennas (e.g., antennas 852 of FIG. 8). In certain aspects, the transmission and/or reception of signals by the UE may be implemented via a bus interface of one or more processors (e.g., controller/processor 880) obtaining and/or outputting signals.

The operations 300 may begin, at 305, by receiving one or more uplink grants (e.g., Type-1 configured uplink grants) from a BS. The one or more uplink grants configure a plurality of TOs (e.g., a sequence of consecutive TOs) for uplink transmission by the UE and a plurality of frequency locations associated with each TO. The set of associated frequency locations may change (e.g., be adjusted, updated, or reconfigured over time). The one or more uplink grants may be configured semi-statically by the BS, for example, via radio resource control (RRC) signaling. The uplink grants may configure the UEs with a period in which the plurality of TOs are configured, a time domain offset of the TOs within the period, a number of repetitions of the TOs within the period, and/or a demodulation reference signal (DMRS) sequence to use for uplink transmission in the TO.

At 310, the UE randomly determines one of the plurality of associated frequency locations, for each of the configured TOs, for uplink transmission in the TO. The UE may be configured by the BS for the random determination.

In some examples, the UE is configured to randomly select one of the plurality of associated frequency locations for each configured TO. For example, the UE may use a random number generator to select among the frequency locations associated with a TO, to use for that TO.

In some examples, the UE is configured to select the frequency locations based on a frequency hopping pattern. The BS may configure the UE for the frequency hopping. The BS may configure the UE with a seed for generating the frequency hopping pattern. The UE may be configured to generate the frequency hopping pattern based on an identifier of the UE (e.g., the radio network temporary identifier (RNTI)). In some examples, the UE is configured with a formula for generating the frequency hopping pattern. In some examples, the frequency hopping pattern, seed, or formula is hardcoded in the UE (e.g., according to an IEEE wireless specification). The frequency hopping pattern may span the sequence of configured TOs in a period, or may cover multiple periods and/or multiple sequences of TOs.

At 315, the UE sends uplink transmissions to the BS in one or more of the configured TOs at the determined frequency locations for the one or more TOs.

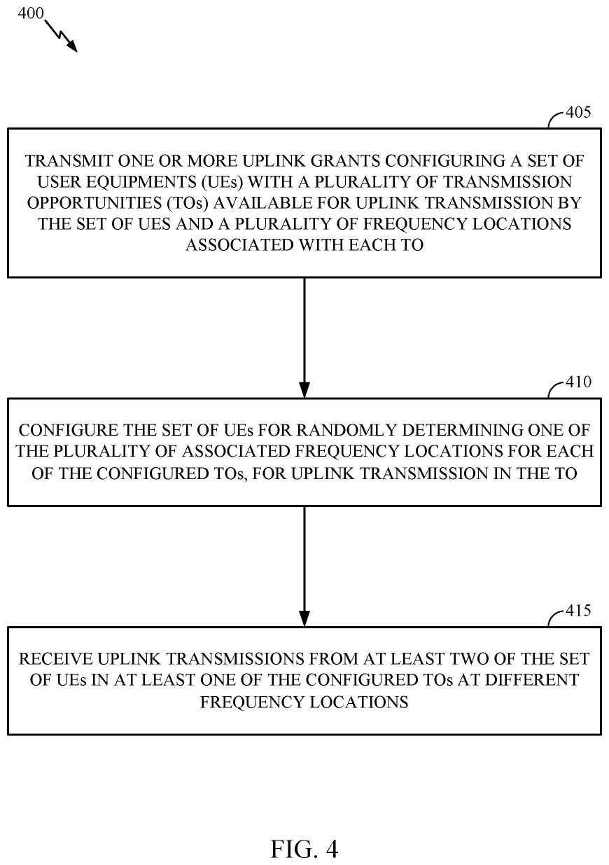

FIG. 4 illustrates example operations 400 for wireless communications, in accordance with certain aspects of the present disclosure. The operations 400 may be performed, for example, by a BS (e.g., such as the BS 110s in the wireless communication network 100). The operations 400 may be complementary operations by the BS to the operations 300 performed by the UE. Operations 400 may be implemented as software components that are executed and run on one or more processors (e.g., controller/processor 840 of FIG. 8). Further, the transmission and reception of signals by the BS in operations 400 may be enabled, for example, by one or more antennas (e.g., antennas 834 of FIG. 8). In certain aspects, the transmission and/or reception of signals by the BS may be implemented via a bus interface of one or more processors (e.g., controller/processor 840) obtaining and/or outputting signals.

The operations 400 may begin, at 405, by transmitting one or more uplink grants (e.g., a Type-1 uplink grant) configuring (e.g., via RRC) a set of UEs with a plurality of TOs (e.g., sequential or non-sequential TOs) available for uplink transmission by the set of UEs and a plurality of frequency locations associated with each TO. The one or more uplink grants configure a period of the TO, a time domain offset of the TO, a number of repetitions of the TO, and/or a demodulation reference signal (DMRS) sequence to use for uplink transmission in the TO.

At 410, the BS configures the set of UEs for randomly determining one of the plurality of associated frequency locations for each of the configured TOs, for uplink transmission. For example, the UE configures the set of UEs to randomly select one of the plurality of associated frequency locations for each configured TO. The BS may adjust the configured associated frequency locations after a duration. The BS may configure the set of UEs to randomly select the frequency location based on a random generator. The BS may configure the set of UEs with one or more frequency hopping patterns for selecting the frequency locations for the configured TOs. The frequency hopping patterns may cover multiple sequences of TOs. The BS may configure the set of UEs with seeds for generating the frequency hopping patterns. The frequency hopping patterns may be based on a seed generated based on an identifier of the UE (e.g., RNTI). The BS may configure the set of UEs with a frequency hopping pattern, a seed for generating the frequency hopping pattern, and/or a formula for generating the seed.

At 415, the BS receives uplink transmissions from at least two of the set of UEs in at least one of the configured TOs at different frequency locations. According to certain aspects, if the UEs are configured to randomly select the frequency locations for the UE, then the BS may blindly decode uplink transmissions for the set of UEs. On the other hand, if the UE configures the UE to select the frequency locations based on a frequency hopping pattern, then the BS may know the hopping pattern and can decode the uplink transmissions at the frequency locations based on the hopping pattern.

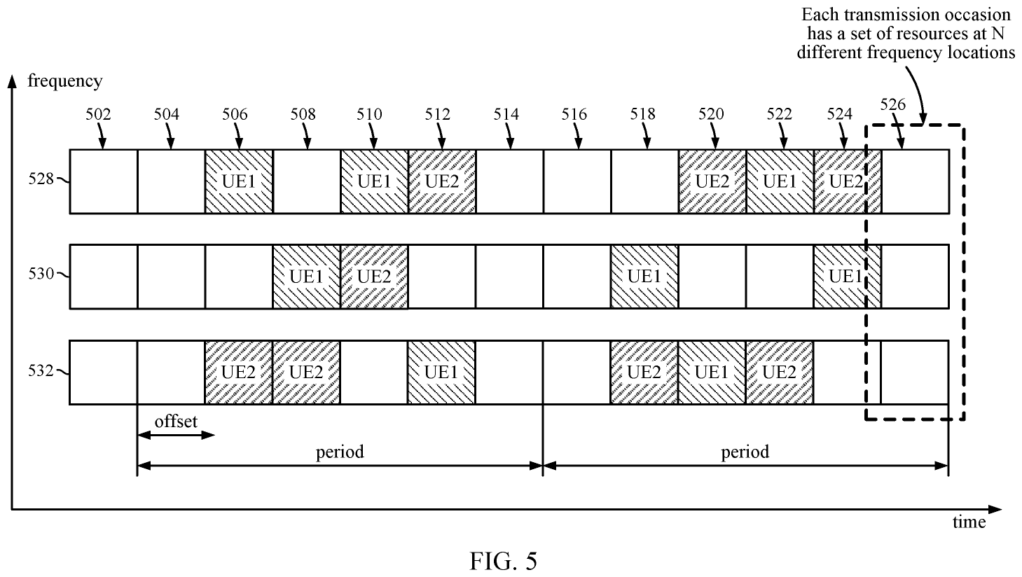

FIG. 5 shows example TOs scheduled for Type-1 uplink grants with frequency hopping, in accordance with certain aspects of the present disclosure. In the example shown in FIG. 5, each TO (TO 502, 504, . . . , 526) is associated with three different frequency locations 528, 530, 532. Although in FIG. 5, the TOs are configured with the same frequency locations, in other examples, different TOs may be associated with different frequency locations and/or different numbers of frequency locations. In some examples, the associated frequency locations change over time (e.g., are adjusted, updated, or reconfigured). As shown in FIG. 5, the UE 1, UE 2, and UE 3 share the TOs, but may select different frequency locations in the TOs. Thus, collisions may be reduced or avoided.

According to certain aspects, the UE is configured (e.g., by the BS) to randomly choose among the frequency resource available for a TO. This random choice may be applied to each TO within a repetition (e.g., a sequence in a period) and/or across periods (e.g., to multiple sequences).

According to certain aspects, the UE is configured (e.g., by the BS or hardcoded according to the wireless standards) with a pseudo-random hopping sequence (hopping pattern) that specifies which frequency location to use over time (e.g., in different TOs). This pseudo-random sequence may be long and span multiple periods. The seed for the hopping sequence may be either explicitly configured by network, or generated based on UE's RNTI (e.g., according to a formula), in a way such that each UE has a unique sequence to use. The hopping sequence, seed, or formula for generating the hopping sequence may be signaled by the BS or preconfigured (e.g., hardcoded) at the IDE.

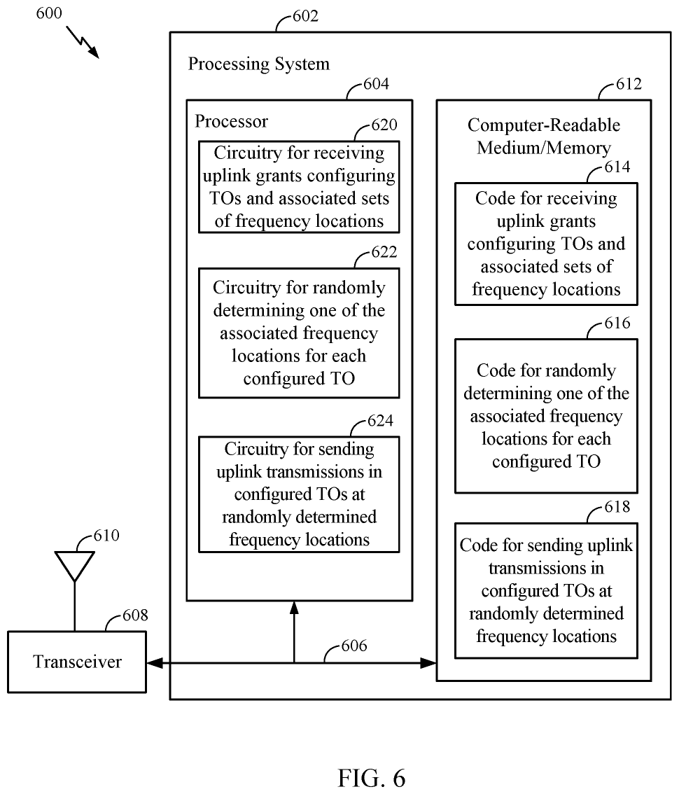

FIG. 6 illustrates a communications device 600 that may include various components (e.g., corresponding to means-plus-function components) configured to perform operations for the techniques disclosed herein, such as the operations illustrated in FIG. 3. The communications device 600 includes a processing system 602 coupled to a transceiver 608. The transceiver 608 is configured to transmit and receive signals for the communications device 600 via an antenna 610, such as the various signals as described herein. The processing system 602 may be configured to perform processing functions for the communications device 600, including processing signals received and/or to be transmitted by the communications device 600.

The processing system 602 includes a processor 604 coupled to a computer-readable medium/memory 612 via a bus 606. In certain aspects, the computer-readable medium/memory 612 is configured to store instructions (e.g., computer executable code) that when executed by the processor 604, cause the processor 604 to perform the operations illustrated in FIG. 3, or other operations for performing the various techniques discussed herein for randomized frequency locations for uplink grants. In certain aspects, computer-readable medium/memory 612 stores code 614 for receiving uplink grants configured TOs and associated set of frequency locations; code 616 for randomly determining one of the associated frequency locations for each configured TO; and code 618 for sending uplink transmissions in the configured TOs at the determined frequency locations, in accordance with aspects of the present disclosure. In certain aspects, the processor 604 has circuitry configured to implement the code stored in the computer-readable medium/memory 612. The processor 604 includes circuitry 620 for receiving uplink grants; circuitry 622 for randomly determining frequency locations; and circuitry 624 for sending uplink transmissions, in accordance with aspects of the present disclosure.

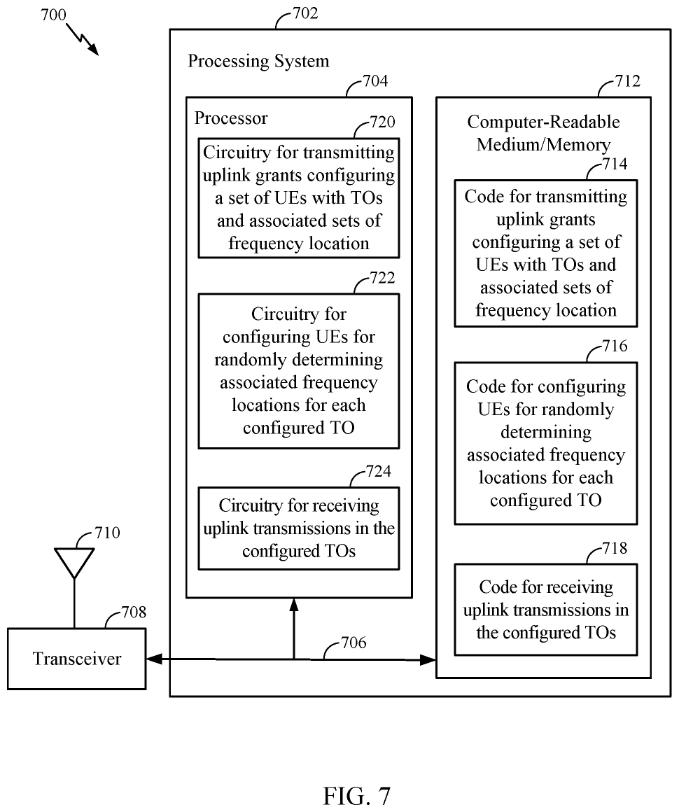

FIG. 7 illustrates a communications device 700 that may include various components (e.g., corresponding to means-plus-function components) configured to perform operations for the techniques disclosed herein, such as the operations illustrated in FIG. 4. The communications device 700 includes a processing system 702 coupled to a transceiver 708. The transceiver 708 is configured to transmit and receive signals for the communications device 700 via an antenna 710, such as the various signals as described herein. The processing system 702 may be configured to perform processing functions for the communications device 700, including processing signals received and/or to be transmitted by the communications device 700.

The processing system 702 includes a processor 704 coupled to a computer-readable medium/memory 712 via a bus 706. In certain aspects, the computer-readable medium/memory 712 is configured to store instructions (e.g., computer executable code) that when executed by the processor 704, cause the processor 704 to perform the operations illustrated in FIG. 4, or other operations for performing the various techniques discussed herein for randomized frequency locations for uplink grants. In certain aspects, computer-readable medium/memory 712 stores code 714 for transmitting uplink grants configuring a set of UEs with TOs and associated sets of frequency locations; code 716 for configuring UEs for randomly determining associated frequency locations for each configured TO; and code 718 for receiving uplink transmissions in the configured TOs, in accordance with aspects of the present disclosure. In certain aspects, the processor 704 has circuitry configured to implement the code stored in the computer-readable medium/memory 712. The processor 704 includes circuitry 720 for transmitting uplink grants; circuitry 722 for configuring UEs for randomly determining frequency locations; and circuitry 724 for receiving uplink transmissions, in accordance with aspects of the present disclosure.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The techniques described herein may be used for various wireless communication technologies, such as LTE, CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). NR is an emerging wireless communications technology under development in conjunction with the 5G Technology Forum (SGTF). 3GPP Long Term Evolution (LTE) and LTE-Advanced (LTE-A) are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, while aspects may be described herein using terminology commonly associated with 3G and/or 4G wireless technologies, aspects of the present disclosure can be applied in other generation-based communication systems, such as 5G and later, including NR technologies.

NR access (e.g., 5G NR technology) may support various wireless communication services, such as enhanced mobile broadband (eMBB) targeting wide bandwidth (e.g., 80 MHz or beyond), millimeter wave (mmW) targeting high carrier frequency (e.g., 25 GHz or beyond), massive machine type communications MTC (mMTC) targeting non-backward compatible MTC techniques, and/or mission critical targeting URLLC. These services may include latency and reliability requirements. These services may also have different transmission time intervals (TTI) to meet respective quality of service (QoS) requirements. In addition, these services may co-exist in the same subframe. Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block” (RB)) may be 12 subcarriers (or 180 kHz). Consequently, the nominal Fast Fourier Transfer (FFT) size may be equal to 128, 256, 512, 1024 or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10 or 20 MHz, respectively.

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block” (RB)) may be 12 subcarriers (or 180 kHz). Consequently, the nominal Fast Fourier Transfer (FFT) size may be equal to 128, 256, 512, 1024 or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10 or 20 MHz, respectively.

In LTE, the basic transmission time interval (TTI) or packet duration is the 1 ms subframe. In NR, a subframe is still 1 ms, but the basic TTI is referred to as a slot. A subframe contains a variable number of slots (e.g., 1, 2, 4, 8, 16, . . . slots) depending on the subcarrier spacing. The NR RB is 12 consecutive frequency subcarriers. NR may support a base subcarrier spacing of 15 KHz and other subcarrier spacing may be defined with respect to the base subcarrier spacing, for example, 30 kHz, 60 kHz, 120 kHz, 240 kHz, etc. The symbol and slot lengths scale with the subcarrier spacing. The CP length also depends on the subcarrier spacing.

NR may utilize OFDM with a CP on the uplink and downlink and include support for half-duplex operation using TDD. Beamforming may be supported and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity. In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

FIG. 8 illustrates example components of the BS 110a and UE 120a (as depicted in FIG. 1), which may be used to implement aspects of the present disclosure. For example, antennas 852, processors 866, 858, 864, and/or controller/processor 880 of the UE 120a and/or antennas 834, processors 820, 830, 838, and/or controller/processor 840 of the BS 110a may be used to perform the various techniques and methods described herein for randomized frequency locations for uplink grants.

At the BS 110a, a transmit processor 820 may receive data from a data source 812 and control information from a controller/processor 840. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. The processor 820 may process (e.g., encode and symbol map) the data and control information to obtain data symbols and control symbols, respectively. The processor 820 may also generate reference symbols, e.g., for the primary synchronization signal (PSS), secondary synchronization signal (SSS), and cell-specific reference signal (CRS). A transmit (TX) multiple-input multiple-output (MIMO) processor 830 may perform spatial processing (e.g., precoding) on the data symbols, the control symbols, and/or the reference symbols, if applicable, and may provide output symbol streams to the modulators (MODs) 832a through 832t. Each modulator 832 may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators 832a through 832t may be transmitted via the antennas 834a through 834t, respectively.

At the UE 120a, the antennas 852a through 852r may receive the downlink signals from the BS 110a and may provide received signals to the demodulators (DEMODs) in transceivers 854a through 854r, respectively. Each demodulator 854 may condition (e.g., filter, amplify, downconvert, and digitize) a respective received signal to obtain input samples. Each demodulator may further process the input samples (e.g., for OFDM, etc.) to obtain received symbols. A MIMO detector 856 may obtain received symbols from all the demodulators 854a through 854r, perform MIMO detection on the received symbols if applicable, and provide detected symbols. A receive processor 858 may process (e.g., demodulate, deinterleave, and decode) the detected symbols, provide decoded data for the UE 120a to a data sink 860, and provide decoded control information to a controller/processor 880.

On the uplink, at UE 120a, a transmit processor 864 may receive and process data (e.g., for the physical uplink shared channel (PUSCH)) from a data source 862 and control information (e.g., for the physical uplink control channel (PUCCH) from the controller/processor 880. The transmit processor 864 may also generate reference symbols for a reference signal (e.g., for the sounding reference signal (SRS)). The symbols from the transmit processor 864 may be precoded by a TX MIMO processor 866 if applicable, further processed by the demodulators in transceivers 854a through 854r (e.g., for SC-FDM, etc.), and transmitted to the BS 110a. At the BS 110a, the uplink signals from the UE 120a may be received by the antennas 834, processed by the modulators 832, detected by a MIMO detector 836 if applicable, and further processed by a receive processor 838 to obtain decoded data and control information sent by the UE 120a. The receive processor 838 may provide the decoded data to a data sink 839 and the decoded control information to the controller/processor 840.

The controllers/processors 840 and 880 may direct the operation at the BS 110a and the UE 120a, respectively. The processor 840 and/or other processors and modules at the BS 110a may perform or direct the execution of processes for the techniques described herein. The memories 842 and 882 may store data and program codes for BS 110a and UE 120a, respectively. A scheduler 844 may schedule UEs for data transmission on the downlink and/or uplink.

A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For example, instructions for performing the operations described herein and illustrated in FIG. 3 and FIG. 4.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method of wireless communications by a user equipment (UE), comprising:
receiving one or more uplink grants from a base station (BS) configuring a plurality of transmission opportunities (TOs) for uplink transmission by the UE and a plurality of frequency locations associated with each TO;
randomly determining one of the plurality of associated frequency locations, for each of the configured TOs, for uplink transmission in the TO; and
sending one or more uplink transmissions to the BS in one or more of the configured TOs at the randomly determined frequency locations for the one or more TOs.

2. The method of claim 1, wherein the uplink is a Type-1 configured uplink grant.

3. The method of claim 1, wherein the plurality of TOs are consecutive.

4. The method of claim 1, wherein the one or more uplink grants configure at least one of: a period in which the plurality of TOs are configured, a time domain offset of the TOs within the period, a number of repetitions of the TOs within the period, or a demodulation reference signal (DMRS) sequence to use for uplink transmission in the TO.

5. The method of claim 1, wherein the one or more uplink grants are configured semi-statically via radio resource control (RRC) signaling.

6. The method of claim 1, wherein randomly determining the frequency locations for the configured TOs comprises randomly selecting one of the plurality of associated frequency locations for each configured TO.

7. The method of claim 6, further comprising receiving another one or more uplink grants configuring different associated frequency locations after a duration.

8. The method of claim 6, wherein the random selection is based on a random generator.

9. The method of claim 1, wherein randomly determining the frequency locations for the configured TOs comprises selecting the frequency locations based on a frequency hopping pattern.

10. The method of claim 9, wherein the frequency hopping pattern covers multiple sequences of TOs.

11. The method of claim 9, wherein the frequency hopping pattern is based on a seed received from the BS.

12. The method of claim 9, wherein the frequency hopping pattern is based on a seed generated based on an identifier of the UE.

13. The method of claim 12, wherein the identifier of the UE is a radio network temporary identifier (RNTI).

14. The method of claim 9, wherein the UE is configured with the frequency hopping pattern, a seed for generating the frequency hopping pattern, or a formula for generating the seed.

15. A method of wireless communications by a base station (BS), comprising:
transmitting one or more uplink grants configuring a set of user equipments (UEs) with a plurality of transmission opportunities (TOs) available for uplink transmission by the set of UEs and a plurality of frequency locations associated with each TO;
configuring the set of UEs for randomly determining one of the plurality of associated frequency locations, for each of the configured TOs, for uplink transmission in the TO; and
receiving uplink transmissions from at least two of the set of UEs in at least one of the configured TOs at different frequency locations.

16. The method of claim 15, wherein the uplink is a Type-1 configured uplink grant.

17. The method of claim 15, wherein the plurality of TOs are consecutive.

18. The method of claim 15, wherein the one or more uplink grants configure at least one of: a period of the TO, a time domain offset of the TO, a number of repetitions of the TO, or a demodulation reference signal (DMRS) sequence to use for uplink transmission in the TO.

19. The method of claim 15, wherein the one or more uplink grants are configured semi-statically via radio resource control (RRC) signaling.

20. The method of claim 15, wherein configuring the set of UEs for randomly determining the frequency locations for the configured TOs comprises configuring the set of UEs to randomly select one of the plurality of associated frequency locations for each configured TO.

21. The method of claim 20, further comprising adjusting the configured associated frequency locations after a duration.

22. The method of claim 20, wherein the set of UEs are configured to randomly select the frequency location based on a random generator.

23. The method of claim 20, wherein receiving the uplink transmissions comprises blindly decoding transmission from the set of UEs.

24. The method of claim 15, wherein configuring the set of UEs for randomly determining the frequency locations comprises configuring the set of UEs with one or more frequency hopping patterns for selecting the frequency locations for the configured TOs.

25. The method of claim 24, wherein the frequency hopping patterns cover multiple sequences of TOs.

26. The method of claim 24, wherein configuring the frequency hopping patterns comprises configuring the set of UEs with seeds for generating the frequency hopping patterns.

27. The method of claim 24, wherein the frequency hopping patterns are based on a seed generated based on an identifier of the UE.

28. The method of claim 24, wherein the set of UEs is configured with the frequency hopping pattern, a seed for generating the frequency hopping patterns, or a formula for generating the seed.

29. An apparatus for wireless communications, comprising:
means for receiving one or more uplink grants from another apparatus configuring a plurality of transmission opportunities (TOs) for uplink transmission by the apparatus and a plurality of frequency locations associated with each TO;
means for randomly determining one of the plurality of associated frequency locations, for each of the configured TOs, for uplink transmission in the TO; and
means for sending one or more uplink transmissions to the other apparatus in one or more of the configured TOs at the randomly determined frequency locations for the one or more TOs.

30. An apparatus for wireless communications, comprising:
means for transmitting one or more uplink grants configuring a set of user equipments (UEs) with a plurality of transmission opportunities (TOs) available for uplink transmission by the set of UEs and a plurality of frequency locations associated with each TO;
means for configuring the set of UEs for randomly determining one of the plurality of associated frequency locations, for each of the configured TOs, for uplink transmission in the TO; and
means for receiving uplink transmissions from at least two of the set of UEs in at least one of the configured TOs at different frequency locations.
